(19) United States
(12) Patent Application Publication
(10) Pub. No.: US 2010/0025401 A1
(43) Pub. Date: Feb. 4, 2010

(54) RELIEF VALVE

(75) Inventors: Thomas M. Jagemann, Two Rivers, WI (US); Peter John Mayer, Green Bay, WI (US); Michael Thomas Jagemann, Manitowoc, WI (US)

Correspondence Address: FOLEY & LARDNER LLP, 777 EAST WISCONSIN AVENUE, MILWAUKEE, WI, 53202-5306, US

(73) Assignee: Jagemann Stamping Company

(21) Appl. No.: 12/539,524

(22) Filed: Aug. 11, 2009

Related U.S. Application Data
(63) Continuation-in-part of application No. 11/963,746, filed on Dec. 21, 2007.

(51) Int. Cl. B65D 51/16; F16K 15/00

(52) U.S. Cl. 220/203.29; 137/511; 137/15.19

(57) ABSTRACT

A relief valve including a generally cylindrical housing with first and second openings. The first opening is defined by a flange having an internal shoulder located adjacent the first opening. A pin is provided in the housing and has a first end and a second end opposite of the first end. A spring is positioned about the pin. A seal is located at the second end of the pin and adjacent the second opening of the housing. A clip is located at the first end of the pin and engages the internal shoulder of the flange to compress the spring between the clip and the seal.

### CROSS-REFERENCE TO RELATED PATENT APPLICATIONS

This application is a Continuation-in-Part of U.S. patent application Ser. No. 11/963,746, filed Dec. 21, 2007, the entire disclosure of which is incorporated herein by reference.

### BACKGROUND

The present invention relates generally to the field of relief valves. More specifically, the present invention relates to relief valves of the type which can be used with non-refillable gas cylinders. Relief valves for non-refillable gas cylinders present a number of material selection, structural configuration and manufacturing challenges for engineers and manufacturers. Attempting to address one challenge may give rise to other challenges, issues, and/or hurdles. For example, some relief valves have a hollow cylindrical housing or sleeve coupled to the body of the gas cylinder and a spring-loaded insert or core that is attached to the housing with a threaded connection. However, such a threaded connection requires very tight tolerances to ensure a close, reliable fit between the housing and core. The threaded connection may also have problems with cross-threading when installing the valve mechanism. Additionally, there may be dissimilar metal and manufacturing concerns which necessitate the increase or unnecessary use of relatively expensive materials such as brass.

There are many impediments to the development of a relief valve. Some impediments may include market resistance to changes, cost, limitations in manufacturing equipment, quality control, governmental regulations and laws, limitations on the types of acceptable materials, limitations on the types of materials which can be placed in contact with the type of gas contained in the gas cylinders, thermal characteristics, assembling and packaging requirements, and transportation durability requirements to name a few. As a result, the combination of one or more of these impediments had deterred and taught away from the development of such relief valves.

It would be advantageous to provide a relief valve capable of being reliable, easily secured to a gas cylinder, and efficiently mass produced so that there is an acceptable range of variability from valve to valve.

### SUMMARY

One embodiment of the disclosure relates to a relief valve including a generally cylindrical housing with first and second openings. The first opening is defined by a flange having an internal shoulder located adjacent the first opening. A pin is provided in the housing and has a first end and a second end opposite of the first end. A spring is positioned about the pin. A seal is located at the second end of the pin and adjacent the second opening of the housing. A clip is located at the first end of the pin and engages the internal shoulder of the flange to compress the spring between the clip and the seal.

Another embodiment of the disclosure relates to a gas canister including a cylinder having a first opening and a second opening smaller than the first opening. The gas canister further includes a main valve provided in the first opening and a relief valve provided in the second opening. The relief valve includes a generally cylindrical housing with first and second openings. The first opening is defined by a flange having an internal shoulder located adjacent the first opening. A pin is provided in the housing and has a first end and a second end opposite of the first end. A spring is positioned about the pin. A seal is located at the second end of the pin and is adjacent the second opening of the housing. A clip is located at the first end of the pin. The clip engages the internal shoulder of the flange to compress the spring between the clip and the seal.

Another embodiment of the disclosure relates to a pressure relief valve for a gas canister including a one-piece tubular housing having a flange at a first end thereof. The flange includes a first portion extending outward from the housing to form a ledge and a second portion folded over the first portion and extending inward to define a first opening of the housing. The second portion overlaps the first portion to create an internal shoulder. A pin is provided in the housing and includes a retainer adjacent a first end thereof. A spring is positioned about the pin and is retained by a first side of the retainer. A seal is retained by a second side of the retainer and is adjacent a second opening of the housing. A clip includes a center portion having an aperture configured to receive a second end of the pin and at least two arms extending outward from the center portion at an angle such that an edge of each of the at least two arms is in contact with the internal shoulder of the flange to compress the seal into the second opening of the housing.

Another embodiment of the disclosure relates to a method of manufacturing a gas canister. The method includes providing a cylinder and coupling a relief valve housing to the cylinder. The relief valve housing has an internal shoulder formed by a flange. The method also includes selecting a spring and a clip corresponding to a specific gas retention pressure. The method further includes assembling a relief valve core comprising a pin, a seal, the spring, and the clip. The method still further includes inserting the relief valve core into the housing such that the clip engages the internal shoulder of the flange to compress the spring between the clip and the seal.

### BRIEF DESCRIPTION OF THE DRAWINGS

FIG. 1 is an isometric view of a gas canister including a relief valve according to an exemplary embodiment.

FIG. 2 is a cross-section of the canister of FIG. 1 taken along line 2-2.

FIG. 3 is a cross-section of the canister of FIG. 1 taken along line 3-3 showing the relief valve according to an exemplary embodiment.

FIG. 4 is an exploded view of the relief valve of FIG. 1 according to an exemplary embodiment.

FIG. 5 is a cross-section of the relief valve of FIG. 1 showing the assembly of the relief valve according to an exemplary embodiment.

FIG. 6 is an isometric view of a relief valve according to another exemplary embodiment.

FIG. 7 is a side view of the relief valve of FIG. 6.

FIG. 8 is a top view of the relief valve of FIG. 6.

FIG. 9 is a bottom view of the relief valve of FIG. 6.

FIG. 10 is a cross-section of the relief valve of FIG. 7 taken along line 10-10.

FIG. 11 is a flowchart of a method of manufacturing a gas canister including a relief valve according to an exemplary embodiment.

### DETAILED DESCRIPTION

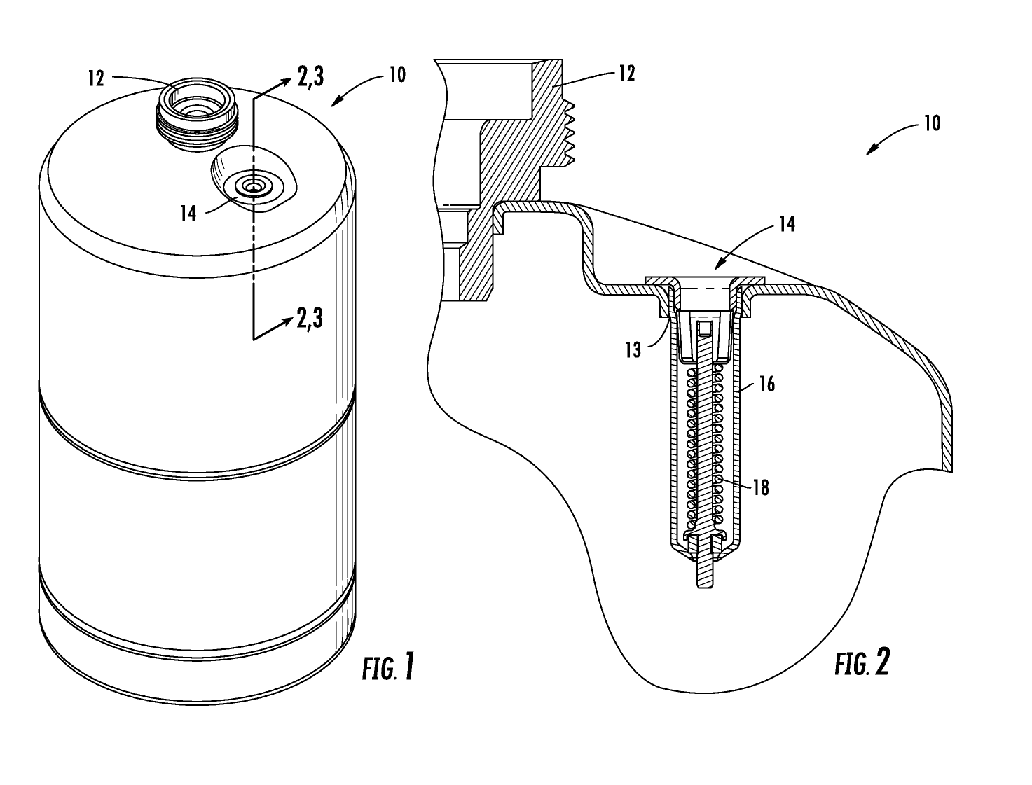

Referring to FIG. 1, a container, shown as a gas canister or cylinder 10, includes a relief valve 14. Cylinder 10 is a thin-walled metal canister formed from a metal (e.g., carbon steel, stainless steel, aluminum, etc.) that is configured to hold a pressurized gas. Gas cylinders 10 are generally narrow cylindrical bodies with a mostly flat bottom and a rounded top. The rounded top generally has two openings: a first opening for a relief valve 14 and a second, larger opening for a main valve 12. Such gas cylinders 10 may be used in a variety of applications, such as camping, grilling, brazing or welding. According to an exemplary embodiment, cylinder 10 is formed from 1008 cold rolled steel with a deep drawing process. Cylinder 10 may be formed in multiple portions that are coupled together with welding, brazing, or another suitable process.

Gas cylinders 10 may contain a wide range of gases including, but not limited to propane, propylene, oxygen, or a mixture of liquefied petroleum gas and methylacetylene-propadiene (e.g., MAPP® gas). The gas is normally released from cylinder 10 through a main valve 12 provided on the top of cylinder 10. Main valve 12 is inserted in an opening on gas cylinder 10. Main valve 12 receives a gas regulator (not shown) that allows a user to selectively release gas from gas cylinder 10. Gas regulators may then be connected to an appliance, such as a grill, lantern or hand held torch.

Relief valve 14 is inserted into an opening 13 in gas cylinder 10 and is provided to allow gas to escape the interior of cylinder 10 if the pressure inside cylinder 10 exceeds a predetermined level. Pressure inside cylinder 10 may increase, for example, if cylinder 10 is exposed to high temperatures that cause the gas inside cylinder 10 to expand. Additionally, in the case of a liquefied compressed gas, such as MAPP® gas or propane, an increase in temperature may cause the liquid in cylinder 10 to change to a gas, thus increasing the pressure inside cylinder 10. Relief valve 14 helps to reduce the chance of cylinder 10 bursting. Referring to FIG. 2, relief valve 14 is inserted into opening 13 in the top of cylinder 10 and coupled to the cylinder 10 with a suitable process such as welding or brazing.

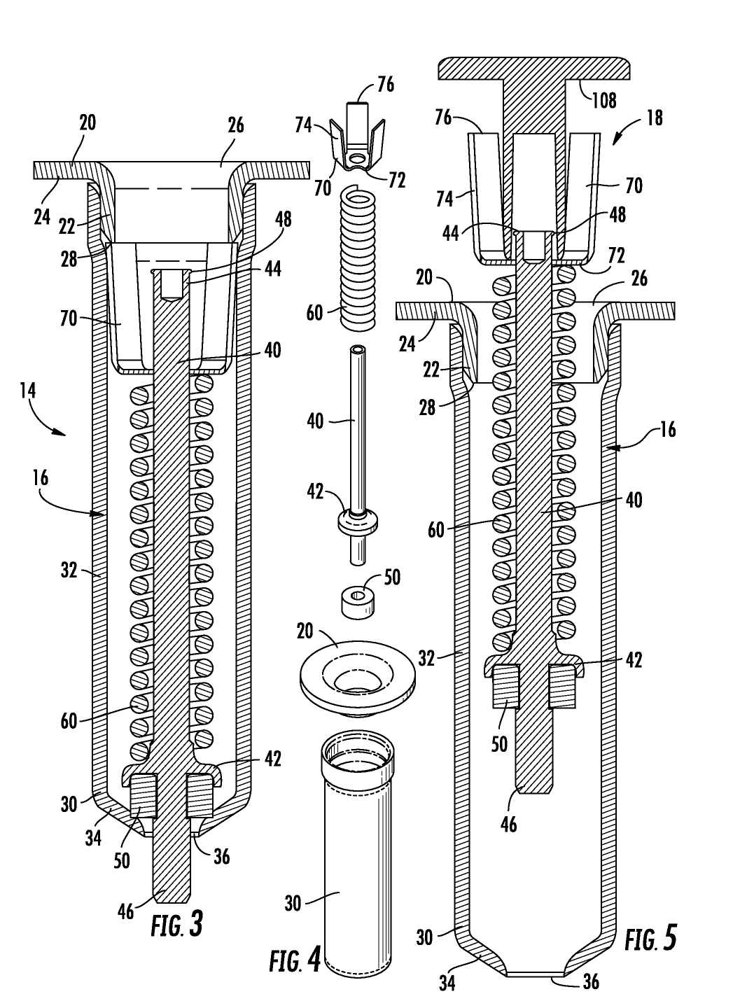

Referring now to FIGS. 3-5, a relief valve 14 is shown in more detail according to one exemplary embodiment. Relief valve 14 includes a housing shown as tubular housing 16, a pin 40 received by housing 16, a seal 50 coupled to pin 40, a spring 60 positioned about pin 40 that biases seal 50 against housing 16, and a clip 70 that retains pin 40, seal 50, and spring 60 within housing 16.

Housing 16 is generally a tubular member that is received by an opening in cylinder 10 and provides the main body of relief valve 14. Housing 16 may be a single unitary member, or may be constructed of multiple components. As shown in FIGS. 3-5, a first member or portion 20 of housing 16 includes a neck 22 and a flange 24 that extends outward from the upper edge of neck 22. First portion 20 defines a first opening 26 of housing 16. A second member or portion 30 of housing 16 includes a generally cylindrical side wall 32 and a lower end that extends inward to provide an internal seat 34 (e.g., ledge, shelf, end wall, etc.). A second opening 36 is adjacent to seat 34. Second opening 36 is configured to receive an end of pin 40. Neck 22 of first portion 20 is configured to nest within side wall 32 of second portion 30.

According to one exemplary embodiment, first portion 20 and second portion 30 are formed from a metal (e.g., carbon steel, stainless steel, aluminum, etc.). According to a preferred embodiment, first portion 20 and second portion 30 are formed from a cold rolled steel. According to a further preferred embodiment, first portion 20 and second portion 30 are formed from a metal coil with a deep drawing process using ASTM AS1008 DS Type B cold rolled steel.

According to an alternative embodiment, first portion 20 may be formed from a copper-clad 1008 steel or any other suitable material. First portion 20 may be coupled to second portion 30 by welding (e.g., laser welding, friction welding, MIG welding, TIG welding, etc.), brazing, or another suitable coupling method. Housing 16 is pressed into an opening 13 in cylinder 10. Housing 16 may also be coupled to cylinder 10 by welding (e.g., laser welding, friction welding, MIG welding, TIG welding, etc.), brazing, or another suitable coupling method. Flange 24 extends outward beyond side wall 32 and is configured to rest on the outer surface of cylinder 10. Flange 24 is coupled to cylinder 10 with a suitable coupling method such as brazing or welding. In an alternate embodiment, flange 24 may be formed from a copper-clad 1008 steel, and coupled to cylinder 10 by heating up both flange 24 and cylinder 10 so that flange 24 is brazed to cylinder 10 as part of an assembly process.

As shown in FIGS. 3-5, housing 16 has an internal shoulder 28 located adjacent the first opening 26. Shoulder 28 may be formed from machining housing 16 (when housing 16 is a single unitary body) or may be formed when first portion 20 is inserted into second portion 30. As shown in the figures, first portion 20 has a smaller diameter neck 22 that fits into second portion 30, creating shoulder 28.

Pin 40 is an elongated member or rod that is received within housing 16. Pin 40 includes an upper or first end 44, a lower or second end 46, and an integrally formed flange or retainer 42 that extends outward from pin 40 adjacent to second end 46. Retainer 42 is configured to retain seal 50 on one side and spring 60 on the opposite side. Second end 46 is configured to receive seal 50. First end 44 may be configured to retain clip 70.

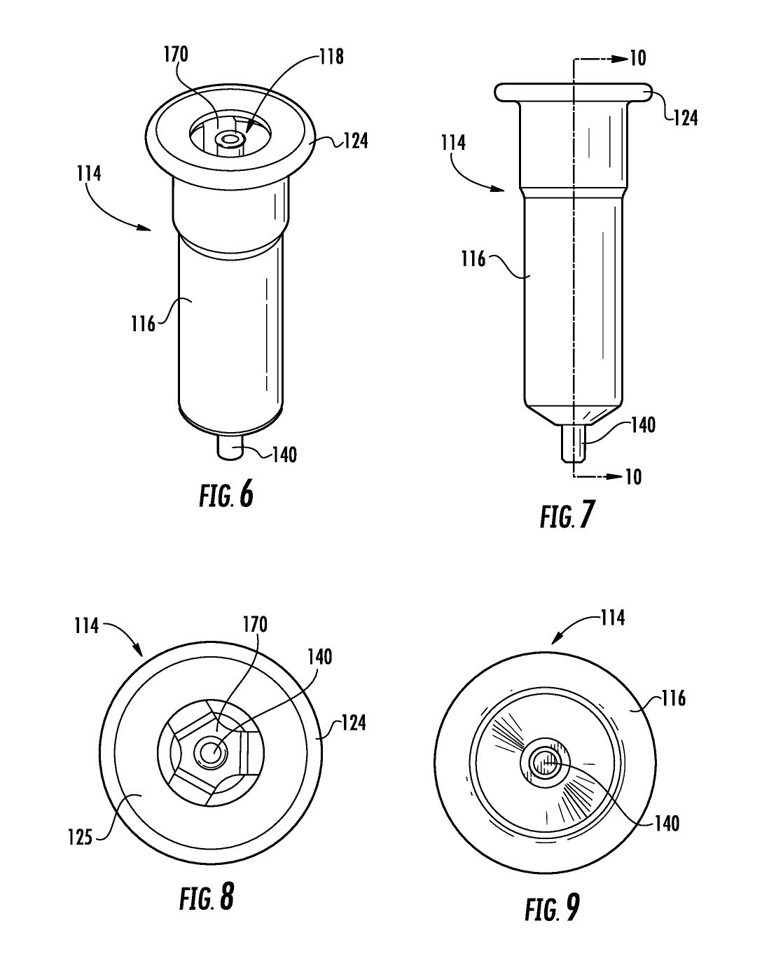

As shown in FIGS. 3 and 5, first end 44 may be deformed or upset to create ridge 48. Ridge 48 may be configured to retain clip 70 to pin 40 during assembly of a valve core assembly 18. According to an exemplary embodiment, pin 40 is formed from UNS C26000 brass wire, another brass, or any other suitable material. According to one exemplary embodiment, retainer 42 is integrally formed with pin 40 in a cold heading process. According to other exemplary embodiments, retainer 42 and pin 40 may be formed separately and coupled (e.g., welded, brazed, etc.) together.

Seal 50 is a compressible member that is formed (e.g., molded, extruded and cut, die cut, etc.) from a resilient material (e.g., acrylonitrile-butadiene rubber (NBR)) or other suitable material. Seal 50 includes a central hole that allows seal 50 to be coupled to second end 46 of pin 40 proximate to retainer 52. As shown in FIGS. 3 and 4, the second end 46 of pin 40 shows a reduced diameter where it passes through the center of the seal 50. The reduced diameter may help in coupling seal 50 to pin 40. According to an alternative embodiment pin 40 has a constant diameter from second end 46 to the retainer 42. Seal 50 may be retained by friction alone to the constant diameter of second end 46 of pin 40. Retainer 42 stops seal 50 from being forced along pin 40 towards first end 44.

Spring 60 is a coil spring and may be formed from any suitable material (e.g., 302 stainless steel). Spring 60 is configured to bias seal 50 towards housing 16. Spring 60 is positioned around pin 40 and is trapped or retained between retainer 42 and clip 70.

Clip 70 is formed from a resilient material such as spring steel and is configured to retain pin 40, seal 50, and spring 60 inside housing 16. According to an exemplary embodiment, clip 70 is a stamped member formed from half-hard tempered 302 stainless steel. Clip 70 includes a central portion 72 with an opening that is configured to receive first end 44 of pin 40. Clip 70 further includes multiple arms 74 that extend outward from central portion 72. In a free-state or position, edges 76 of arms 74 form a perimeter (i.e., a free-state perimeter) that is larger than the diameter of second portion 30 of housing 16.

Clip 70 may be constructed in different shapes and sizes. For instance, different shapes and sizes of clip 70 may be used in relief valves for cylinders configured to hold gases under different pressures. In one embodiment, clip 70 may have longer arms 74 to obtain a higher gas retention pressure. In another embodiment, clip 70 may have shorter arms 74 to obtain a lower gas retention pressure. Additionally, clip 70 may be made of a thicker or thinner material to compress the spring a specific amount in order to develop the required gas retention pressure. In an alternative embodiment, spring 60 may be formed in various sizes and with various spring coefficients to achieve various gas retention pressures.

As shown in FIG. 5, pin 40, seal 50, spring 60, and clip 70 are assembled into a valve core assembly 18. Second end 46 of pin 40 may be configured to retain seal 50 or seal 50 may be configured to be coupled to pin 40. First end 44 of pin 40 may be deformed or upset to retain clip 70 on pin 40. As valve core assembly 18 is inserted into housing 16, arms 74 of clip 70 are compressed inward by neck 22. When valve core assembly 18 is fully inserted into housing 16, arms 74 clear neck 22 and are allowed to bias outward. Spring 60 biases clip 70 away from seal 50 and against an inner shelf or shoulder 28 formed adjacent the end of neck 22. With seal 50 biased against seat 34 and edges 76 of clip 70 biased against shoulder 28, valve core assembly 18 is trapped or retained in housing 16.

As shown in FIGS. 3 and 5, shoulder 28 is located on first portion 20 of housing 16. In an alternative embodiment, shoulder 28 may be located on second portion 30 of housing 16. In another alternative embodiment, shoulder 28 maybe located on housing 16 when housing 16 is a single unitary body. Shoulder 28 provides a square or flat seat for positive retention of clip 70. Positive retention of clip 70 locks clip 70 into housing 16, thus positively retaining or locking valve core assembly 18 into housing 16.

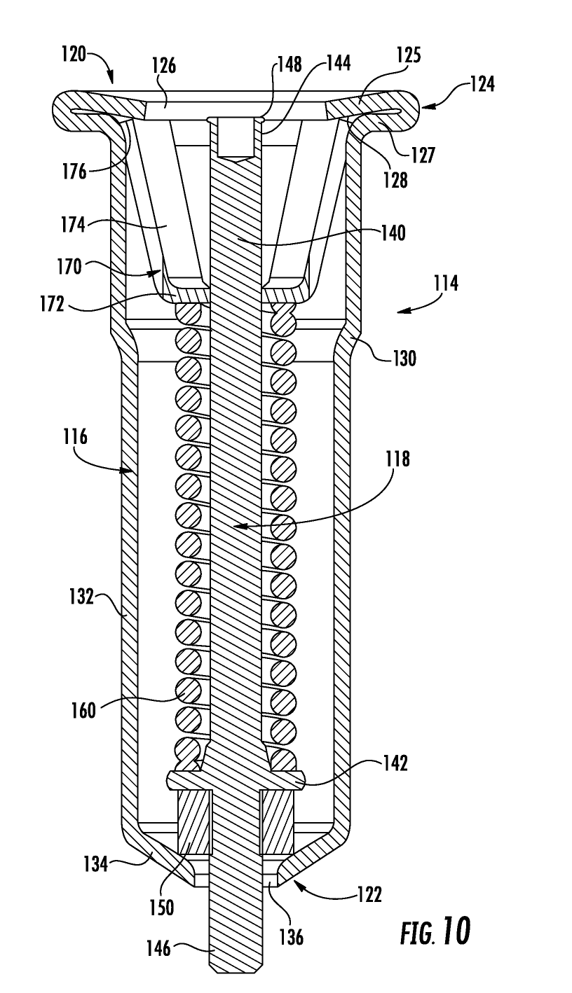

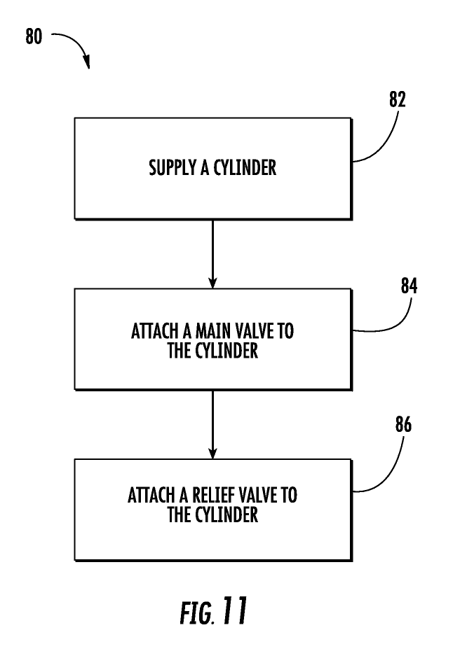

Referring now to FIGS. 6-10, a relief valve 114 is shown according to another exemplary embodiment. Relief valve 114 includes a container or housing shown as housing 116 and a valve core assembly 118. Valve core assembly 118 is received in housing 116 and includes a pin 140, a seal 150 coupled to pin 140, a spring 160 positioned about pin 140 that biases seal 150 against housing 116, and a clip 170 that retains pin 140, seal 150, and spring 160 within housing 116.

According to an exemplary embodiment, housing 116 is a generally tubular member that is received by an opening 13 in cylinder 10 and provides the main body of relief valve 114. Housing 116 includes a first end 120 and a second end 122 opposite of first end 120. First end 120 defines a first opening 126, while second end 122 defines a second opening 136. First end 120 includes a lip or flange 124 that defines first opening 126. Second end 122 extends inward to provide an internal seat 134 (e.g., ledge, shelf, end wall, etc.) that is adjacent to second opening 136. Housing 116 may be a single unitary member (as shown in FIGS. 6-10), or may be constructed of multiple components.

As shown in FIG. 10, housing 116 includes a generally cylindrical side wall 132. Side wall 132 may have a substantially constant external diameter or may include a transition or neck down region 130 between first end 120 and second end 122 (e.g., as shown in FIG. 10). Neck down region 130 creates a first external diameter above region 130 and a second external diameter below region 130 that is smaller than the first external diameter. The smaller second external diameter provides for a clearance space for when housing 116 is inserted into cylinder 10. As shown in FIG. 10, region 130 may be located approximately ⅓ of the way down from first end 120 of housing 116. According to other exemplary embodiments, region 130 may be located closer to or further away from first end 120 of housing 116.

As shown best in FIG. 10, flange 124 of housing 116 includes a first or upper portion 125 and a second or lower portion 127. Lower portion 127 is connected to side wall 132 at first end 120 of the housing 116. Lower portion 127 extends outward from side wall 132 to form a ledge or shelf that is used in coupling the relief valve 114 to cylinder 10.

Connected to lower portion 127 is upper portion 125. In the embodiment shown in FIG. 10, upper portion 125 is folded (e.g., doubles back) over lower portion 127 in order to form an internal shoulder 128 (e.g., shelf, lip, ledge, edge, sill, projection, rim, etc.). Upper portion 125 defines first opening 126 such that shoulder 128 is located adjacent to first opening 126.

According to one exemplary embodiment, housing 116 is formed from a metal (e.g., carbon steel, stainless steel, aluminum, etc.). According to a preferred embodiment, housing 116 is formed from a cold rolled steel. According to a further preferred embodiment, housing 116 is formed from a metal coil with a deep drawing process using ASTM AS1008 DS Type B cold rolled steel. According to an alternative embodiment, housing 116 may be formed from a copper-clad 1008 steel or any other suitable material.

According to an exemplary embodiment, housing 116 is pressed into an opening 13 of cylinder 10. Housing 116 may also be coupled to cylinder 10 by welding (e.g., laser welding, friction welding, MIG welding, TIG welding, etc.), brazing, or another suitable coupling method. Lower portion 127 of flange 124 extends outward beyond side wall 132 of housing 116 and is configured to rest on the outer surface of cylinder 10. Flange 124 of housing 116 is coupled to cylinder 10 with a suitable coupling method such as those described above. In an alternate embodiment, flange 124 may be formed from a copper-clad 1008 steel, and coupled to cylinder 10 by heating up both flange 124 and cylinder 10 so that flange 124 is brazed to cylinder 10 as part of an assembly process.

As shown best in FIG. 10, pin 140 is an elongated member or rod that is received within housing 116. Pin 140 includes an upper or first end 144 and a lower or second end 146 opposite of first end 144. First end 144 may be configured to retain clip 170. For example, as shown in FIG. 10, first end 144 may be deformed or upset to create ridge 148. Ridge 148 may be configured to retain clip 170 to pin 140 during assembly of valve core assembly 118. According to other various embodiments, first end 144 may be otherwise deformed (e.g., pinched, crimped, clamped, etc.) to retain clip 170 during assembly of valve core assembly 118. According to an exemplary embodiment, second end 146 is configured to extend at least partially through second opening 136.

Pin 140 also includes a flange or retainer 142 that extends outward from pin 140 adjacent to second end 146. Retainer 142 is configured to retain seal 150 on one side and spring 160 on the opposite side. According to an exemplary embodiment, retainer 142 may be integrally formed with pin 140 (e.g., by a cold heading process). According to another exemplary embodiment, retainer 142 may be a separate component from pin 140 and coupled to pin 140 (e.g., by welding, brazing, etc.). According to an exemplary embodiment, pin 140 is formed from UNS C26000 brass wire, another brass, or any other suitable material (e.g., such as steel).

Seal 150 is a compressible member that is formed (e.g., molded, extruded and cut, die cut, etc.) from a resilient material (e.g., acrylonitrile-butadiene rubber (NBR)) or other suitable material. Seal 150 includes a central hole that allows seal 150 to be coupled to second end 146 of pin 140 proximate to retainer 152. As shown in FIG. 10, the second end 146 of pin 140 has a reduced diameter where it passes through the center of seal 150. The reduced diameter may help in coupling seal 150 to pin 140.

According to an alternative embodiment, pin 140 has a constant diameter from second end 146 to the retainer 142. In this embodiment, seal 150 may be retained by friction alone to the constant diameter of second end 146 of pin 140. Retainer 142 stops seal 150 from being moved along pin 140 towards first end 144.

Spring 160 is a coil spring and may be formed from any suitable material (e.g., 302 stainless steel). Spring 160 is configured to bias seal 150 towards housing 116. Spring 160 is positioned around pin 140 and is trapped or retained between retainer 142 and clip 170.

Clip 170 is formed from a resilient material such as spring steel and is configured to retain pin 140, seal 150, and spring 160 inside housing 116. According to an exemplary embodiment, clip 170 is a stamped member having a substantially constant thickness (e.g., formed from half-hard tempered 302 stainless steel). According to another exemplary embodiment, clip 170 has a thickness of about 2 mm, but may vary more or less according to other exemplary embodiments.

Clip 170 includes a central portion 172 with an opening that is configured to receive first end 144 of pin 140. Clip 170 further includes at least one arm 174 that extends upward and/or outward from central portion 172. According to one exemplary embodiment, clip 170 includes at least two arms 174. According to another exemplary embodiment, clip 170 includes at least three arms 174.

In a free-state or position, edges 176 of arms 174 form a perimeter (i.e., a free-state perimeter) that is larger than the internal diameter of housing 116. According to an exemplary embodiment, the arms 174 have a length that is larger than the external diameter of the central portion 172 (e.g., by 1.1-2 times larger), but may vary according to other exemplary embodiments.

According to another exemplary embodiment, the arms 174 form an angle of approximately 100-110 degrees with central portion 172 when retained in housing 116, but may vary more or less according to other exemplary embodiments. The combination of the length and/or angle of arms 174 aid in the secure retention of clip 170 in housing 116 and prevent clip 170 (and relief valve core 118) from escaping housing 116.

According to another exemplary embodiment, clip 170 may comprise a single arm 174 that is generally in the shape of a circular disc or washer. According to another exemplary embodiment, clip 170 and housing 116 (e.g., upper portion 125 of flange 124) may be keyed with respect to one another (e.g., in a tab and slot configuration, etc.). For example, edge 176 of clip 170 may include a tab or projection that aligns with a slot or indentation of housing 116. Clip 170 may then be pushed or slid into housing 116 (when the tab and slot are aligned) and then rotated in order to lock clip 170 into place. In these embodiments, the edge 176 and/or the arm 174 of clip 170 may be modified with different shapes and/or rigidities to accomplish these functions.

According to various exemplary embodiments, clip 170 may be constructed in different shapes, sizes, and/or rigidities. For instance, different shapes, sizes, and/or rigidities of clip 170 may be used in relief valves for cylinders configured to hold gases under different pressures. In one embodiment, clip 170 may have longer arms 174 to obtain a higher gas retention pressure. In another embodiment, clip 170 may have shorter arms 174 to obtain a lower gas retention pressure. Additionally, clip 170 may be made of a thicker or thinner material to compress the spring a specific amount in order to develop the required gas retention pressure. In an alternative embodiment, spring 160 may be formed in various sizes and with various spring coefficients to achieve various gas retention pressures.

As shown in FIG. 10, pin 140, seal 150, spring 160, and clip 170 are assembled into a valve core assembly 118. Second end 146 of pin 140 may be configured to retain seal 150 or seal 150 may be configured to be coupled to pin 140. First end 144 of pin 140 may be deformed or upset to retain clip 170 on pin 140.

As valve core assembly 118 is inserted into housing 116, arms 174 of clip 170 are compressed inward by first opening 126. When valve core assembly 118 is fully inserted into housing 116, arms 174 clear first opening 126 and are allowed to bias outward. According to an exemplary embodiment, the arms 174 exert a force (e.g., a lateral spring force) against the inner diameter of housing 116.

Additionally, spring 160 biases clip 170 away from seal 150 and against shoulder 128 formed by upper portion 125 of flange 124. With seal 150 biased against seat 134 and edges 176 of clip 170 biased against shoulder 128, valve core assembly 118 is trapped or retained in housing 116. Shoulder 128 provides a square or flat seat for positive retention of clip 170. Positive retention of clip 170 locks clip 170 into housing 116, thus positively retaining or locking valve core assembly 118 into housing 116.

Referring now to FIG. 11, a method of manufacturing a gas canister 80 is shown according to an exemplary embodiment. A first step 82 includes supplying a cylinder 10. According to an exemplary embodiment, cylinder 10 is formed from 1008 cold rolled steel with a deep drawing process. Cylinder 10 may be formed in multiple portions that are coupled together with welding, brazing, or another suitable process. Cylinder 10 includes a first opening for a relief valve 14, 114 and a second, larger opening for a main valve 12.

A next step 84 includes attaching main valve 12 to cylinder 10. A next step 86 includes attaching relief valve 14, 114 to cylinder 10. According to an exemplary embodiment, housing 16, 116 of relief valve 14, 114 is pressed into opening 13 in cylinder 10 and is coupled to cylinder 10 with a suitable coupling method such as brazing or welding. Valve core assembly 18, 118 is inserted into housing 16, 116 until retainer clip 70, 170 engages shoulder 28, 128.

According to an exemplary embodiment, a valve core assembly tool 108 (e.g., as shown in FIG. 5) may be used to insert valve core assembly 18, 118 into housing 16, 116. The valve core assembly tool 108 may surround the first end 44, 144 of pin 40, 140 and press on clip 70, 170 to insert valve core assembly 18, 118 into housing 16, 116. When surrounding the first end 44, 144, the valve core assembly tool may be inserted into or around the first end 44, 144 of pin 40, 140. Additionally, the valve core assembly tool 108 may hold, retain, or guide pin 40, 140 when pressing or pushing on clip 70, 170. The valve core assembly tool 108 may be constructed of hardened tool steel or other suitable materials. The valve core assembly tool 108 may be retrofitted on current relief valve assembly machines and may rotate or not rotate when operated.

Relief valve 14, 114 is inserted into an opening 13 in gas cylinder 10 and is provided to allow gas to escape the interior of cylinder 10 if the pressure inside cylinder 10 exceeds a predetermined level. Pressure inside cylinder 10 may increase, for example, if cylinder 10 is exposed to high temperatures that cause the gas inside cylinder 10 to expand. Additionally, in the case of a liquefied compressed gas, such as MAPP® gas or propane, an increase in temperature may cause the liquid in cylinder 10 to change to a gas, thus increasing the pressure inside cylinder 10. Relief valve 14, 114 helps to reduce the chance of cylinder 10 bursting. Relief valve 14, 114 is inserted into opening 13 in the top of cylinder 10 and coupled to the cylinder 10 with a suitable process such as welding or brazing.

If the pressure of the gas in cylinder 10 reaches a predetermined threshold, relief valve 14, 114 is activated. According to an exemplary embodiment, relief valve 14, 114 is configured to retain (i.e., not release) a gas such as propane or MAPP® gas in cylinder 10 at 130 degrees Fahrenheit. Gas pressure from inside cylinder 10 presses outward against seal 50, 150 and compresses spring 60, 160. When seal 50, 150 moves away from seat 34, 134, a passage is created to allow gas to pass through second opening 36, 136 through relief valve 14, 114 and out first opening 26, 126 to the atmosphere. When the gas pressure inside cylinder 10 pressing outward on seal 50, 150 is less than the opposing spring pressure on seal 50, 150 by spring 60, 160, seal 50, 150 is biased towards seat 34, 134, closing second opening 36, 136.

The pressure at which relief valve 14, 114 begins to allow gas to escape cylinder 10 is the set or “start-to-discharge” pressure. According to an exemplary embodiment, relief valve 14, 114 has a set pressure of at least 300.3 psi for propane and at least 246.8 psi for MAPP® gas. Relief valve 14, 114 is configured to allow at least 18.18 cubic feet per minute free air to pass through at a pressure of 457.6 psi. For the purpose of this disclosure, “free air” is the flow rate adjusted to 16.696 psia and 60 degrees Fahrenheit.

For purposes of this disclosure, the term “coupled” means the joining of two components directly or indirectly to one another. Such joining may be stationary in nature or movable in nature. Such joining may be achieved with two members and any additional intermediate members being integrally formed as a single unitary body with one another or with the two members or the two members and any additional member being attached to one another. Such joining may be permanent in nature or alternatively may be removable or releasable in nature.

The construction and arrangement of the elements of the relief valve shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied. It should be noted that the elements and/or assemblies of the system may be constructed from any of a wide variety of materials that provide sufficient strength or durability, including any of a wide variety of moldable plastic materials in any of a wide variety of colors, textures and combinations. Other substitutions, modifications, changes and omissions may be made in the design, operating conditions and arrangement of the exemplary embodiments.

What is claimed is:

1. A relief valve, comprising:
a generally cylindrical housing including first and second openings, the first opening defined by a flange having an internal shoulder located adjacent the first opening;
a pin provided in the housing and having a first end and a second end opposite of the first end;
a spring positioned about the pin;
a seal located at the second end of the pin and adjacent the second opening of the housing; and
a clip located at the first end of the pin, the clip engaging the internal shoulder of the flange to compress the spring between the clip and the seal.

2. The relief valve of claim 1, wherein the flange comprises a first portion that extends outward from the housing to form a ledge and a second portion that is folded over the first portion to form the internal shoulder.

3. The relief valve of claim 1, wherein the clip comprises a center portion provided around the pin and at least two arms extending outward from the center portion at an angle.

4. The relief valve of claim 1, wherein the clip has a substantially constant thickness.

5. The relief valve of claim 1, wherein the clip comprises at least three arms.

6. The relief valve of claim 5, wherein edges of the at least three arms of the clip define a free-state perimeter that is larger than the internal diameter of the housing.

7. The relief valve of claim 6, wherein the length of the at least three arms of the clip is such that the at least two arms of the clip exert a lateral force against an inner diameter of the housing.

8. The relief valve of claim 1, further comprising a retainer adjacent the second end of the pin, the retainer having a first side configured to retain the spring and a second side configured to retain the seal.

9. The relief valve of claim 1, wherein the housing is a single unitary body.

10. A gas canister, comprising:
a cylinder having a first opening and a second opening smaller than the first opening;
a main valve provided in the first opening; and
a relief valve provided in the second opening, the relief valve comprising:
a generally cylindrical housing including first and second openings, the first opening defined by a flange having an internal shoulder located adjacent the first opening;
a pin provided in the housing and having a first end and a second end opposite of the first end;
a spring positioned about the pin;
a seal located at the second end of the pin and adjacent the second opening of the housing; and
a clip located at the first end of the pin, the clip engaging the internal shoulder of the flange to compress the spring between the clip and the seal.

11. The gas canister of claim 10, wherein the flange comprises a first portion that extends outward from the housing to form a ledge and a second portion that is folded over the first portion to form the internal shoulder.

12. The gas canister of claim 10, wherein the housing comprises a neck down region to provide a clearance space for when the relief valve is provided in the second opening of the cylinder.

13. The gas canister of claim 10, further comprising a gas regulator coupled to the main valve and an appliance coupled to the gas regulator.

14. The gas canister of claim 13, wherein the appliance is a hand-held torch, a grill, or a lantern.

15. A pressure relief valve for a gas canister, comprising:
a one-piece tubular housing comprising a flange at a first end thereof, the flange comprising a first portion extending outward from the housing to form a ledge and a second portion folded over the first portion and extending inward to define a first opening of the housing, the second portion overlapping the first portion to create an internal shoulder;
a pin provided in the housing and including a retainer adjacent a first end thereof;
a spring positioned about the pin and retained by a first side of the retainer;
a seal retained by a second side of the retainer and adjacent a second opening of the housing; and
a clip comprising a center portion having an aperture configured to receive a second end of the pin and at least two arms extending outward from the center portion at an angle such that an edge of each of the at least two arms is in contact with the internal shoulder of the flange to compress the seal into the second opening of the housing.

16. The pressure relief valve of claim 15, wherein the clip comprises at least three arms.

17. A method of manufacturing a gas canister, comprising the steps:
providing a cylinder;
coupling a relief valve housing to the cylinder, the housing having an internal shoulder formed by a flange;
selecting a spring and a clip corresponding to a specific gas retention pressure;
assembling a relief valve core comprising a pin, a seal, the spring, and the clip;
inserting the relief valve core into the housing such that the clip engages the internal shoulder of the flange to compress the spring between the clip and the seal.

18. The method of claim 17, wherein the flange comprises a first portion that extends outward from the housing to form a ledge and a second portion that is folded over the first portion to form the internal shoulder.

19. The method of claim 18, wherein the clip is compressed by the second portion of the flange when being inserted into the housing.

20. The method of claim 17, wherein the clip comprises at least two arms that extend outward from a center portion thereof at an angle.

21. The method of claim 20, wherein the at least two arms of the clip exert a lateral force against an inner diameter of the housing to aid in retention of the relief valve core inside the housing.

22. The method of claim 17, wherein the relief valve core is slid into the housing.
